(19) United States
(12) Patent Application Publication
(10) Pub. No.: US 2025/0131775 A1
(43) Pub. Date: Apr. 24, 2025

(54) COMPUTER-IMPLEMENTED METHOD FOR A DATA EXCHANGE BETWEEN A FILLING STATION AND A CLIENT, CONTROLLER FOR CONTROLLING THE HYDROGEN PRODUCTION AND/OR HYDROGEN PREPARATION, SYSTEM FOR CONTROLLING THE HYDROGEN PRODUCTION AND/OR HYDROGEN PREPARATION, AND COMPUTER PROGRAM

(71) Applicant: ARGO GMBH, Wesel (DE)

(72) Inventor: Jan ANDREAS, Wesel (DE)

(21) Appl. No.: 18/688,293

(22) PCT Filed: Aug. 30, 2022
(86) PCT No.: PCT/EP2022/074059

§ 371 Date: Feb. 29, 2024

(30) Foreign Application Priority Data
Sep. 1, 2021 (DE) 10 2021 209 626.3

(51) Int. Cl. G07C 5/00; G06Q 10/02; G06Q 50/06

(52) U.S. Cl. CPC G07C 5/008; G06Q 10/02; G06Q 50/06

(57) ABSTRACT

A method for data exchange between a refueling station and a client, including: transmitting a refueling request from the client to the refueling station via wireless data transmission, receiving at least two refueling proposals from the refueling station, wherein the at least two transmitted refueling proposals differ from one another in at least one proposed refueling parameter, selected from the group of: refueling time, refueling duration, maximum filling amount, maximum filling speed, energy required for refueling on the part of the refueling station, price of hydrogen, waiting time before refueling, type of energy used to produce the hydrogen to be refueled, CO2 certificate, environmental certificate. Also disclosed is a method for controlling a refueling process of a vehicle, for detecting a client consumption pattern or a client refueling pattern, for controlling hydrogen production or hydrogen treatment for refueling at least one vehicle, a controller, a system, and a remote server.

### TECHNICAL FIELD

The present invention relates to a computer-implemented method for data exchange between a refueling station and a client, a computer-implemented method for controlling, with and/or without feedback, a refueling process of a vehicle, a computer-implemented method for detecting a client refueling pattern, a computer-implemented method for controlling, with and/or without feedback, hydrogen production and/or hydrogen treatment, and a system for producing and/or treating hydrogen. Furthermore, the present invention relates to a remote server (cloud-based server), a computer program and a computer-readable storage medium.

### PRIOR ART

Recently, for political and environmental reasons, there has been a growing interest in electrically powered vehicles or motor vehicles, particularly vehicles equipped with a battery to provide electrical power. In commercial vehicles, aircraft or ships, the use of batteries is often impractical due to their high weight. That is why the industry's focus in this context is more on vehicles with fuel cell drives. In the automotive sector, too, a number of car manufacturers have been focusing on hydrogen propulsion in the long term. Here, the vehicles are equipped with a fuel cell to provide electrical energy, with hydrogen being used as the energy source for the fuel cells. For this purpose, the hydrogen is stored in high-pressure storage tanks permanently installed in the vehicle, at a pressure of up to 700 bar. In the future, pressures of up to 1000 bar are conceivable. Research is also currently being conducted into the storage of cryogenic hydrogen at pressures in the range of up to 350 bar.

However, in order to increase consumer acceptance of vehicles powered by electric motors, in particular automobiles, it is necessary to make hydrogen widely available and to simplify the refueling (filling) of the vehicles with hydrogen. Regardless of whether the hydrogen is provided or refueled in cryogenic or gaseous form, the hydrogen is introduced or filled into the vehicle-side high-pressure storage tank (hydrogen tank) at hydrogen refueling stations at a temperature below the freezing point of water. With regard to the refueling or filling of motor vehicle pressure tanks with gaseous hydrogen at a pressure of up to 700 bar, SAE Standard J2601 has been introduced, according to which the hydrogen supplied from the hydrogen refueling station to the vehicle, in particular the high-pressure storage tank installed on the vehicle, is conditioned as a function of one or more boundary conditions. In this regard, it is particularly necessary to cool the hydrogen to a temperature between minus 20° C. and minus 40° C. to prevent the hydrogen from reaching critical temperatures in the range of 90° C. to 100° C. during refueling, particularly during injection into the high-pressure storage tank, which could damage the high-pressure storage tank. This can only be achieved if the hydrogen is suitably preconditioned, in particular cooled, by the refueling station. It should be noted here that hydrogen in the cryogenic state also requires preconditioning. If sufficiently cold hydrogen (minus 40° C. to 0° C., preferably minus 40° C. to minus 20° C.) is not available, only slow refueling can be performed. In the case of passenger cars, refueling is considered to be slow if it takes between 10 and 15 minutes and a hydrogen amount of approximately 3 to 5 kg is refueled. By contrast, normal refueling takes about 3 minutes, during which time between 3 and 5 kg of hydrogen are also filled into the vehicle.

At present, there is no data exchange between hydrogen-powered vehicles and hydrogen refueling stations, which means that hydrogen refueling stations prophylactically store a relatively large amount of hydrogen in order to have enough hydrogen available to refuel potential customers, which leads to a high energy expenditure on the part of the hydrogen refueling stations and thus a high price for the hydrogen provided. This has a negative impact on the acceptance of hydrogen-powered vehicles. On the other hand, if the refueling stations attempt to keep the amount of prophylactically stored hydrogen to a minimum in order to save energy, this can lead, first, to unnecessarily long waiting times for the customers if there is not enough hydrogen available and, second, to the need for the hydrogen available to be compressed or cooled more quickly than would otherwise be possible, resulting in higher energy expenditure.

Therefore, there is a great need for measures that enable hydrogen refueling stations to more precisely forecast the hydrogen to be kept available, particularly in conditioned form, in order to be able to reduce the energy needed to produce the hydrogen required and thus the price of the hydrogen to be provided.

### DESCRIPTION OF THE INVENTION

Against the background of the need described above, one object of the present invention is to provide a computer-implemented method for data exchange between at least one refueling station and a client, in particular a mobile terminal, an electronic communication device of a vehicle, a smartphone and the like, a computer-implemented method for detecting a client consumption pattern and/or client refueling pattern, in particular of a vehicle driver of a vehicle preferably powered by hydrogen, a computer-implemented method for controlling hydrogen production and/or hydrogen treatment for refueling at least one vehicle, in particular by a hydrogen refueling station, as well as a system for producing and/or treating hydrogen for refueling at least one vehicle, a remote server (cloud-based server), a computer program as well as a computer-readable storage medium, which are able to forecast more precisely the hydrogen, in particular hydrogen in conditioned form, to be provided by a refueling station, in particular hydrogen refueling station, in order to be able to reduce the energy expenditure for the production of the hydrogen required and thus the price for the hydrogen to be provided.

The aforementioned object is solved by a computer-implemented method for data exchange between at least one refueling station and a client according to claim 1, a computer-implemented method for controlling, with and/or without feedback, a refueling process of a vehicle according to claim 28, a computer-implemented method for detecting a client consumption pattern and/or a client a refueling pattern according to claim 32, a computer-implemented method for controlling hydrogen production and/or hydrogen treatment for refueling at least one vehicle according to claim 35, a controller for controlling, with and/or without feedback, hydrogen production and/or hydrogen treatment for refueling at least one vehicle according to claim 37, a system for producing and/or treating hydrogen for refueling at least one vehicle according to claim 38, a remote server (cloud-based server) according to claim 40, a computer program according to claim 41, and a computer-readable storage medium according to claim 42. Preferred further developments of the invention are specified in the dependent claims, wherein the method features of the claims relating to the computer-implemented methods can be used in the respective other computer-implemented methods, the controller, the system, the remote server and the computer program, and vice versa.

One of the basic ideas of the present invention is to provide a means for data exchange between at least one refueling station and at least one client, enabling the transmission of a refueling request from the at least one client to the at least one refueling station as well as the generation of at least two (different) refueling proposals by the at least one refueling station in response to the refueling request of the at least one client, which are transmitted to the client, wherein the at least two generated and/or transmitted refueling proposals differ from one another in at least one proposed refueling parameter. Here, the at least two proposed refueling parameters that differ from one another can be selected from the group of: refueling time, refueling duration, maximum filling amount, maximum filling speed (l/s), energy required for refueling, price of hydrogen, waiting time before refueling, type of energy used to produce the hydrogen to be refueled, and the like.

According to one aspect of the present invention, a computer-implemented method for data exchange between at least one refueling station, in particular hydrogen refueling station, and a client, in particular a mobile terminal, an electronic communication device or vehicle controller of a vehicle, a smartphone and the like, comprises:
transmitting a refueling request from the client to the at least one refueling station via wireless data transmission,
receiving at least two refueling proposals from the at least one refueling station for the client's refueling request via the wireless data transmission,
wherein the at least two transmitted refueling proposals differ from one another in at least one proposed refueling parameter, selected from the group of: refueling time, refueling duration, maximum filling amount (refueled amount of hydrogen), maximum filling speed (l/s), energy required for refueling and/or providing the hydrogen by the refueling station, price of hydrogen, waiting time before refueling, type of energy used to produce the hydrogen to be refueled (e.g. grey, blue or green hydrogen), CO₂ certificate, environmental certificate, and the like.

Within the scope of the present invention, the term “vehicle” or “transport means” or other similar terms as used hereinbelow includes motor vehicles in general, such as passenger cars including sports utility vehicles (SUVs), buses, trucks, various commercial vehicles, water vehicles including various boats and ships, aircraft and the like, hybrid vehicles, electric vehicles, plug-in hybrid electric vehicles, hydrogen vehicles and other alternative vehicles (e.g. fuels which are obtained from resources other than petroleum). As stated herein, a hybrid vehicle is a vehicle with two or more energy sources, for example, petrol-powered and simultaneously electric-powered vehicles. Also included are drones such as surveillance drones, transport drones or passenger drones.

Furthermore, in the context of the present invention, the term “client” means any user that is able to communicate with other clients or a host via wireless connection such as digital mobile communications, wireless local network (W-LAN, “Wireless Local Area Network”), Bluetooth and the like, via a server or a server program. In the present case, the at least one refueling station represents the host in the smallest network (client-refueling station).

The at least one refueling station (the “host”) provides the necessary database (data server) for the data exchange. In the case of a larger network comprising several refueling stations and several clients, an independent data server (remote server or cloud-based server) can be provided via which the plurality of refueling stations and clients can communicate with each other. In this case, the independent data server or remote server represents the host.

According to one embodiment of the present invention, the computer-implemented method can further comprise:
preselecting at least one desired refueling parameter (αdesired) selected from the group of: refueling time, refueling duration, maximum filling amount (refueled amount of hydrogen), maximum filling speed (l/s), maximum energy required for refueling (by the refueling station), price of hydrogen, waiting time before refueling, type of energy used to produce the hydrogen to be refueled (e.g. grey, blue or green hydrogen), a CO₂ certificate or environmental certificate and the like is desired by the client, in particular by a user of the client, prior to the transmission of the refueling request from the client to the at least one refueling station.

Here, the refueling request may preferably include the at least one desired refueling parameter (αdesired).

Furthermore, it is advantageous that the at least two transmitted refueling proposals have the at least one desired refueling parameter in common and differ from each other in at least one of the remaining proposed refueling parameters (αproposed), with the proposed refueling parameters (αproposed) being preferably determined taking into account the desired refueling parameters (αdesired).

In other words, if the client desires, for example, a maximum waiting time of 10 minutes, but the requested refueling station is already very busy at the earliest time when the client could arrive there for refueling, and therefore, according to experience, refueling within a waiting time of 10 minutes is not possible, the refueling station or a management system (system) suggests to the client a later time when refueling within a waiting time of 10 minutes can certainly take place.

On the other hand, if the client desires a certain maximum hydrogen price which cannot currently be offered by the refueling station or is not possible owing to the heavy use of the refueling station, the refueling station or the management system can propose to the client another time, e.g. at night, when the electricity prices and thus the costs for producing the hydrogen are lower. However, it is also possible that there is a surplus of renewable energy such as solar energy due to strong winds or on a very sunny day, in which case the refueling station or the management system can actively offer the clients a reduced hydrogen price in order to increase the demand for desired refueling.

According to another embodiment of the present invention, it can be advantageous that the computer-implemented method further comprises:
selection by the client, in particular by a user of the client, of one of the at least two transmitted refueling proposals, wherein preferably a plurality of refueling proposals are transmitted, and
transmitting a confirmation of the selected refueling proposal from the client to the at least one refueling station or the management system via wireless data transmission,
wherein the at least one refueling station or the management system preferably reserves a corresponding refueling process based on the received confirmation and confirms the reservation to the client.

Furthermore, the computer-implemented method may comprise:
detecting a state and/or operating parameter of the at least one refueling station, preferably by the at least one refueling station or the management system, comprising at least one parameter selected from the group of: amount of stored hydrogen, temperature of stored hydrogen, pressure of stored hydrogen, number of free fuel pumps, number of refueling processes in progress, utilization of the refueling station, energy price, availability of renewable or green energy, number of scheduled (pending or confirmed) refueling processes within a certain time period, costs of the reserved refueling processes depending on the refueling duration specified by the customer (slow filling, normal filling or cold filling), logistics for hydrogen (how much hydrogen can be made available to the refueling station via transport routes such as trucks or pipelines), and the like,
consideration of the desired refueling parameters (α_{desired}) transmitted by the client and/or of the detected state and/or operating parameter of the at least one refueling station in the determination of the at least two refueling proposals, in particular by the at least one refueling station or the management system.

According to another embodiment of the present invention, the computer-implemented method may further comprise:
acquiring data representing at least one scheduled (not yet reserved) or reserved refueling process, comprising data selected from the group of: refueling time, calculated refueling duration, maximum filling amount (refueled amount of hydrogen), maximum filling speed (l/s), maximum energy required for refueling (by the refueling station), calculated price of hydrogen, type of energy used to produce the hydrogen to be refueled,
generating a refueling forecast, in particular forecast refueling schedule, over a predetermined first time period (t1), by applying a refueling schedule forecast algorithm to the acquired data.

Furthermore, it is advantageous that the refueling schedule forecast algorithm has been trained on:
history data or data collection(s) representing an accumulation of individual refueling processes, number and profiles of individual refueling processes performed over a second predetermined time period; and
refueling time or time of day of the respective refueling process within the second predetermined time period.

According to a further embodiment, the second predetermined time period may extend over a period of 10 days, 30 days, 60 days, 90 days, 180 days, one year or two years.

Furthermore, it is preferred that the refueling schedule forecast algorithm has been trained on:
day of the week when the respective refueling process was performed within the second predetermined time period (t2), and/or
day of the year and/or week of the year and/or month of the year when the respective refueling process was performed within the second predetermined time period (t2), and/or
weather conditions during the respective refueling process performed within the second predetermined time period (t2), and/or
outdoor temperature during the respective refueling process performed within the second predetermined time period (t2), and/or
vacation or travel time during the respective refueling process performed within the second predetermined time period (t2), and/or
energy price during the respective refueling process performed within the second predetermined time period (t2), and/or
availability of green energy, in particular wind energy and/or solar energy, during the respective refueling process performed within the second predetermined time period (t2), and/or
geographic location of the at least one refueling station (201, 202) where the respective refueling process was performed within the second predetermined time period (t2) and/or
number of refueling processes performed simultaneously at the at least one refueling station (201, 202) where the respective refueling process was performed within the second predetermined time period (t2), and/or
performance data of the at least one refueling station (201, 202) where the respective refueling process was performed within the second predetermined time period (t2), wherein the performance data preferably comprises at least one performance parameter selected from the group of: maximum hydrogen storage amount (of compressed and cooled hydrogen), hydrogen production rate (Nm³/h) (at 30 bar) (electrolyzer), hydrogen compression rate (Nm³/h) (at 30 bar to 700 bar), hydrogen recooling power (Nm³/h or KW), hydrogen intermediate storage amount (for example at 300 bar), maximum feed-in power of green energy (KW), costs of the reserved refueling processes depending on the time (refueling duration) specified by the customer (slow filling, normal filling or cold filling), logistics for hydrogen (how much hydrogen can be made available to the refueling station via transport routes such as trucks or pipelines).

Furthermore, it is advantageous that the refueling schedule forecast algorithm also takes into account metadata when generating or determining the refueling forecast, the metadata being selected from the group comprising: number of fuel pumps, average dispensing capacity per fuel pump, geographic location, particularly metropolitan area, rural location, proximity to a transport hub, proximity to an industrial area and the like, average annual hydrogen dispensing capacity, and the like.

According to another embodiment, the refueling schedule forecast algorithm may further comprise:
assigning the at least one refueling station to a predetermined cluster or group based on at least one metadata value,
determining a refueling schedule forecast sub-algorithm based on the assigned cluster or group,
wherein the refueling schedule forecast sub-algorithm has preferably been trained on the data of a plurality of different refueling stations, in particular hydrogen refueling stations, which have at least one identical or common metadata value.

In this regard, it is further advantageous that the refueling schedule forecast algorithm is an algorithm, in particular a time-series-forecast algorithm, which is trained on a history/histories or data collection(s) representing an accumulation of individual refueling processes (number and profile of refueling processes) over the second predetermined time period t2, and determines or defines refueling schedule forecasts using one or more machine-learning algorithms.

In this regard, it is further advantageous that based on the refueling schedule forecast sub-algorithm, an individual refueling schedule forecast algorithm is developed by applying the preset refueling schedule forecast sub-algorithm based on acquired history data or data collection(s) representing an accumulation of individual refueling processes (number and profile of refueling processes) over a third predetermined time period (t3) extending after or contiguous to the second predetermined time period, wherein the third time period (t3) preferably extends over 1 day, 2 days, 10 days, 30 days, 60 days, 90 days, 180 days, one year or continuously.

According to a further embodiment of the present invention, the computer-implemented method may further comprise:
acquiring (S10) data representing at least one refueling process performed by the client, preferably a plurality of refueling processes performed by the client, comprising data selected from the group of: refueling time, refueling duration, filling amount (refueled amount of hydrogen), maximum filling speed (l/s), energy required for refueling (by the refueling station), price of hydrogen, type of energy used to produce the refueled hydrogen, within a fourth time period (t4),
generating (S20) a history or data collection of the acquired data over the fourth time period (t4),
generating (S30) a client refueling pattern of hydrogen by applying a client refueling pattern determination algorithm to the generated history or data collection of the acquired data,
wherein the client refueling pattern determination algorithm is an algorithm, in particular a time-series-forecast algorithm, trained on a history/histories or data collection(s) representing an accumulation of individual refueling processes (number and profile of refueling processes) over a fifth predetermined time period (t5), and determines or defines client refueling patterns using one or more machine-learning algorithms.

Furthermore, it is advantageous that the fourth time period (t4) extends over one year, 6 months, 3 months, 1 month, two weeks or 1 week, and/or the fifth time period (t5) extends over 30 days, 60 days, 90 days, 180 days, one year or two years.

In this regard, it may be further preferred that the client refueling pattern determination algorithm has been trained on:
history data or data collection(s) representing an accumulation of individual refueling processes (number and profile of refueling processes) over the fifth time period (t5), and
refueling time or time of day of the respective refueling process within the fifth (predetermined) time period (t5).

Furthermore, it is advantageous that the client refueling pattern determination algorithm has been further trained on:
day of the week when the respective refueling process was performed within the fifth (predetermined) time period (t5), and/or
day of the year and/or week of the year and/or month of the year when the respective refueling process was performed within the fifth (predetermined) time period (t5), and/or
weather conditions during the respective refueling process performed within the fifth (predetermined) time period (t5), and/or
outdoor temperature during the respective refueling process performed within the fifth (predetermined) time period (t5), and/or
vacation or travel time during the respective refueling process performed within the fifth (predetermined) time period (t5), and/or
energy price during the respective refueling process performed within the fifth (predetermined) time period (t5), and/or
availability of green energy, in particular wind energy and/or solar energy, during the respective refueling process performed within the fifth (predetermined) time period (t5), and/or
geographic location of the at least one refueling station (201, 202) where the respective refueling process was performed within the fifth (predetermined) time period (t5), and/or
number of refueling processes performed simultaneously at the at least one refueling station (201, 202) where the respective refueling process was performed within the fifth (predetermined) time period (t5), and/or
amount of hydrogen refueled during the respective refueling process performed within the fifth (predetermined) time period (t5), and/or
refueling speed when performing the respective refueling process within the fifth (predetermined) time period (t5).

According to a further embodiment of the present invention, the client refueling pattern determination algorithm can also take into account metadata when generating or determining the client refueling pattern, the metadata being selected from the group comprising: vehicle type, tank volume of the vehicle, hydrogen consumption (kg/km), age of the driver or drivers, number of drivers, number of family members, geographic location, in particular metropolitan area or rural location, daily commute, average monthly hydrogen consumption, and the like.

It is also preferred that the client refueling pattern determination algorithm further comprises:
assigning the at least one client, in particular driver of a vehicle, to a predetermined cluster or group based on at least one metadata value,
determining a client refueling pattern determination sub-algorithm based on the assigned cluster or group,
wherein the client refueling pattern determination sub-algorithm has preferably been trained on the data of a plurality of (different) clients, in particular drivers of vehicles, having at least one identical or common metadata value.

In this regard, in the computer-implemented method, advantageously at least one client, preferably a plurality of clients, can transmit the determined or defined (detected) client refueling pattern to the at least one refueling station or management system via the wireless data transmission, and the at least one refueling station or the management system can preferably take into account the received client refueling pattern when preparing the refueling forecast, in particular the forecast refueling schedule.

Furthermore, it is advantageous that the at least one refueling station and/or the management system generates a refueling station refueling pattern (schedule of a plurality of scheduled refueling processes over a predetermined time period comprising the respective refueling profiles) when preparing the refueling forecast based on a plurality of received client refueling patterns.

Furthermore, the computer-implemented method may comprise:
creating a default desired refueling profile by the client, in particular an operator of the client, comprising at least one desired refueling parameter (αdesired) selected from the group of: refueling time, refueling duration, maximum filling amount, maximum filling speed (l/s), maximum energy required for refueling, price of hydrogen, waiting time before refueling, type of energy used to produce the hydrogen to be refueled.

Furthermore, it may be advantageous that the at least one refueling station or the management system determines, based on the generated refueling forecast, a utilization of the at least one refueling station, in particular over a predetermined time period, and if the determined utilization of the refueling station is below 80%, preferably below 60%, the refueling station or the management system sends a message to the at least one client, including at least one piece of information (refueling parameter) selected from the group of: refueling without waiting time possible, refueling with high filling speed possible, reduced price of hydrogen, and the like.

According to a further embodiment of the present invention, if the at least one transmitted desired refueling parameter (αdesired) of the client is refueling with green hydrogen, the at least one refueling station or the management system can ensure that the hydrogen to be refueled is or was produced using only renewable energies such as solar energy, wind energy, biomass, hydropower and/or geothermal energy, and preferably log this to the client after the refueling has been performed, in particular by means of a climate certificate (CO2 certificate).

Furthermore, the computer-implemented method may comprise:
collecting refueling requests transmitted by a plurality of clients in a database of a cloud-based server (remote server),
collecting states and/or operating parameters and/or refueling forecasts from a plurality of refueling stations (201, 202) in the database,
transmitting at least two refueling proposals from the database or the management system to at least one of the clients, wherein the collected states and/or operating parameters and/or refueling forecasts of the individual refueling stations and/or the transmitted refueling requests of the plurality of clients are taken into account when preparing the refueling proposals.

Furthermore, it may be advantageous here that based on the collected states and/or operating parameters and/or refueling forecasts of the individual refueling stations and/or the transmitted refueling requests of the plurality of clients and/or client-related parameters selected from the group of: distance to the respective refueling stations, hydrogen amount remaining in the vehicle (of the respective client), scheduled travel route or driving distance of the respective client, optimized refueling proposals are determined, wherein the refueling proposals can be or are optimized preferably with regard to the distance to the selected refueling station, filling speed, waiting time, price of hydrogen, utilization of the refueling station, and the like.

According to a further embodiment of the present invention, a filling process and/or a corresponding suitably located refueling station can be proposed to the client depending on the filling level in the high-pressure storage tank of the vehicle and/or a predetermined driving distance.

It is also advantageous that the wireless data transmission is digital mobile communications.

Furthermore, the present invention relates to a computer-implemented method for controlling, with and/or without feedback, a refueling process of a vehicle and/or client, the method comprising:
checking whether at least one refueling parameter (data) about at least one refueling process already performed on the vehicle or client or a client type (vehicle type or cluster) is available, selected from the group of: refueling duration, filling amount, maximum filling speed, temperature curve of the filled hydrogen, temperature curve of the hydrogen filled into the vehicle-side high-pressure storage tank, refueling curves (delta-P temperature curve).
If at least one refueling process parameter is available for the vehicle to be refueled and/or client and/or client type, this will be taken into account and/or optimized during the refueling or the filling process

In this context, client type, in particular vehicle type or cluster, means that clients or vehicles of the same type, such as Mercedes GLC F-Cell, BMW X5 i Hydrogen, Toyota Mirai and the like, have an identical hydrogen system, such as high-pressure storage tanks, valve technology, hydrogen storage system, hydrogen injector and the like. Accordingly, different refueling parameters may be required to refuel different client types or vehicles. If, for example, one vehicle type has two 2.5 kg high-pressure hydrogen storage tanks and another vehicle type has ten 0.5 kg high-pressure hydrogen storage tanks, it may be that the second vehicle type can be filled more quickly because the amount of hydrogen introduced is distributed over five times the number of storage tanks. On the other hand, in the case where a vehicle type has a modern hydrogen system, such as a swirl-generating injector, then even though there are fewer high-pressure storage tanks, faster refueling may be possible than with older systems with a higher number of hydrogen tanks.

Accordingly, it may be advantageous for the computer-implemented method to call up the vehicle type of the vehicle or client before carrying out the refueling, this can be done via a code attached to the vehicle, in particular a QR code, or via data exchange by means of wireless data transmission.

Furthermore, it is advantageous that the computer-implemented method further comprises:
creating a refueling curve, in particular delta-P temperature curve, based on refueling parameters of the at least one refueling process already performed on the vehicle or client or a client type.

Here, it is advantageous if refueling parameters and/or refueling data are available for a plurality of refueling processes performed on a vehicle or client or client type; in this way, on the one hand, average values can be determined, and on the other hand, the refueling curve created based on the collected refueling parameters and/or refueling data can be optimized.

The refueling curve can be created and/or optimized preferably based on:
available refueling parameters selected from the group of: refueling duration, filling amount, temperature curve of the filled hydrogen, temperature curve of the hydrogen filled into the vehicle-side high-pressure storage tank(s) (start temperature<->end temperature), pressure increase in the vehicle-side high-pressure storage tank(s) and degree of filling achieved, and/or
state and/or operating parameters of a filling device, in particular hydrogen refueling station (201, 202), which is controlled, with and/or without feedback, for refueling the vehicle and/or client, selected from the group of: temperature of stored (available) hydrogen, pressure of stored hydrogen, number of refueling processes in progress, utilization of the refueling station, energy price, availability of renewable or green energy, and number of scheduled (pending or confirmed) refueling processes within a certain time period.

Here, in the context of the present invention, the term “optimize” in connection with the “refueling curve” is to be understood as meaning that, based on available data (e.g. refueling parameters, state and/or operating parameters of the hydrogen refueling station), an attempt is made to adjust the refueling curve (delta-P temperature curve) in such a way that a desired end point of the filling (target high-pressure storage tank pressure, target high-pressure storage tank temperature, target filling amount of hydrogen) is hit as accurately as possible. Individual refueling parameters such as delta-P and/or temperature of the filled hydrogen can be changed over the refueling duration for a plurality of performed refueling processes in order to hit the desired end point more accurately.

On the other hand, the data obtained can be used to offer different refueling modes, selected from the group of: slow filling, normal filling and cold filling, with delta-P being reduced in accordance with the longer refueling duration (e.g. during slow filling) and accordingly less strongly cooled hydrogen (in the range from minus 20° C. to plus 20° C., preferably in the range from 0° C. to plus 20° C.) can be refueled, thus reducing the energy requirement for the refueling process.

Furthermore, it is preferred that in the computer-implemented method the refueling duration of a scheduled refueling process of a vehicle and/or client is reduced by a predetermined or determined value if, when checking the refueling parameters of refueling processes already carried out on the same vehicle, client and/or client type, it is determined that a maximum permissible high-pressure storage tank temperature was not reached at the end of the refueling processes performed.

Furthermore, the present invention relates to a computer-implemented method for detecting a user consumption pattern and/or user refueling pattern, in particular of a driver of a vehicle preferably powered by hydrogen, the method comprising:
acquiring S10 data representing at least one, preferably a plurality of, refueling process performed by a client, comprising data selected from the group of: refueling time, refueling duration, filling amount (refueled amount of hydrogen), maximum filling speed (l/s), energy required for refueling by the refueling station, price of hydrogen at a given time, type of energy used to produce the refueled hydrogen, within a fourth time period t4,
generating S20 a history or data collection of the acquired data over the fourth time period t4,
generating S30 a client refueling pattern of hydrogen by applying a client refueling pattern determination algorithm to the generated history or data collection of the acquired data,
wherein the client refueling pattern determination algorithm is an algorithm, in particular a time-series-forecast algorithm, trained on a history/histories or data collection(s) representing an accumulation of individual refueling processes (number and profile of refueling processes) over a fifth predetermined time period (t5), and determines or defines client refueling patterns using one or more machine-learning algorithms.

According to a further embodiment of the present invention, the fourth time period t4 can extend over one year, 6 months, 3 months, 1 month, two weeks or 1 week, and/or the fifth time period (t5) can extend over 30 days, 60 days, 90 days, 180 days, one year or two years.

Here it is advantageous that the client refueling pattern determination algorithm has been trained on:
history data or data collection(s) representing an accumulation of individual refueling processes (number and profile of refueling processes) over the fifth time period t5, and
refueling time or time of day of the respective refueling process within the fifth predetermined time period t5.

Furthermore, the present invention relates to a computer-implemented method for controlling hydrogen production and/or hydrogen treatment for refueling at least one vehicle by means of a hydrogen refueling station, the method comprising:
creating a refueling station refueling pattern, wherein the refueling station refueling pattern is/was preferably created by the previously described computer-implemented method for data exchange between a refueling station and a client,
detecting a state and/or operating parameter of the hydrogen refueling station, comprising at least one parameter selected from the group of: amount of stored hydrogen, temperature of stored hydrogen, pressure of stored hydrogen, number of free fuel pumps, number of refueling processes in progress, utilization of the refueling station, energy price, availability of renewable or green energy, number of scheduled (pending or confirmed) refueling processes within a certain time period, costs of reserved refueling processes depending on the refueling duration specified by the customer: slow filling, normal filling or cold filling, and logistics for hydrogen (how much hydrogen can be made available to the refueling station via transport routes such as trucks or pipelines),
controlling, with and/or without feedback, hydrogen production and/or hydrogen treatment, taking into account the created refueling station refueling pattern and the detected state and/or operating parameter of the hydrogen refueling station.

Furthermore, the computer-implemented method may comprise:
determining a necessary hydrogen storage amount based on the created refueling station refueling pattern, wherein the amount of stored hydrogen, the cooling temperature of the stored hydrogen, and the pressure of the stored hydrogen are determined based on the created refueling station refueling pattern, in particular the respective refueling profiles (delta-P temperature curve) of the scheduled refueling processes, wherein preferably the hydrogen storage amount, the cooling temperature of the stored hydrogen, and the pressure of the stored hydrogen are kept as low as possible, approximately in a range of 10% to 20% more than a requirement determined on the basis of the refueling station refueling pattern.

Furthermore, the present invention relates to a controller for controlling hydrogen production and/or hydrogen treatment for refueling at least one vehicle, in particular by a hydrogen refueling station, comprising a control unit and means for carrying out the steps of the afore-described computer-implemented method for controlling hydrogen production and/or hydrogen treatment for refueling at least one vehicle.

Furthermore, the present invention relates to a system for producing and/or treating hydrogen for refueling at least one vehicle, in particular hydrogen refueling station, comprising:
a controller, in particular the afore-described controller for controlling hydrogen production and/or hydrogen treatment for refueling at least one vehicle, and means for carrying out the steps of the afore-described computer-implemented method for controlling hydrogen production and/or hydrogen treatment for refueling at least one vehicle.

Furthermore, the system for producing and/or treating hydrogen for refueling at least one vehicle may comprise:
at least one refueling facility,
at least one high-pressure hydrogen storage tank,
at least one dispenser, and
   preferably at least one electrolyzer.

Furthermore, the present invention relates to a system or management system for data exchange between at least one refueling station and at least one client, comprising:
at least one refueling station, in particular hydrogen refueling station,
at least one client, in particular a mobile terminal, an electronic communication device of a vehicle, a smartphone or the like,
a remote server or cloud-based server configured to exchange data between the at least one refueling station, the at least one client and/or the remote server or cloud-based server via wireless data transmission, and
means for carrying out the steps of the afore-described computer-implemented method for data exchange between at least one refueling station and at least one client.

The present invention further relates to a remote server (or cloud-based server) comprising:
a memory (data memory),
a communication interface configured to exchange data between at least one refueling station, in particular hydrogen refueling station, and at least one client, in particular a mobile terminal, an electronic communication device of a vehicle, a smartphone or the like, via wireless data transmission, and
a processor (computer processor; CPU) configured to carry out the afore-described computer-implemented method for data exchange between the at least one refueling station and the at least one client.

Furthermore, the present invention relates to a computer program, in particular an application software (app), comprising commands which, when executed by a computer, in particular a computer of a client selected from the group of: vehicle controller, mobile terminal, smartphone or the like, cause it to execute the afore-described computer-implemented method for data exchange between at least one refueling station and at least one client, the computer-implemented method for controlling, with and/or without feedback, a refueling process, the computer-implemented method for detecting a user consumption pattern and/or user refueling pattern and/or the computer-implemented method for controlling hydrogen production and/or hydrogen treatment for refueling at least one vehicle.

Furthermore, the present invention relates to a computer-readable storage medium, comprising commands which, when executed by a computer, in particular a computer of a client selected from the group of: vehicle controller, mobile terminal, smartphone or the like, cause it to execute the afore-described computer-implemented method for data exchange between at least one refueling station and at least one client, the computer-implemented method for controlling, with and/or without feedback, a refueling process, the computer-implemented method for detecting a user consumption pattern and/or user refueling pattern and/or the computer-implemented method for controlling hydrogen production and/or hydrogen treatment for refueling at least one vehicle.

### BRIEF DESCRIPTION OF THE FIGURES

Further features and advantages of a device, a use and/or a method are set out in the following description of embodiments with reference to the accompanying figures. In these figures:

FIG. 1 schematically shows the structure of a system for data exchange between a vehicle and a refueling station,

FIG. 2 schematically shows the structure of a system for data exchange between a plurality of clients and refueling stations according to an embodiment of the present invention,

FIG. 3 shows a block diagram showing a signal processing hardware of the system shown in FIG. 2 according to an embodiment of the present invention, and

FIG. 4 schematically shows a neural network with artificial neurons with an input layer, hidden layer and output layer.

### DESCRIPTION OF EMBODIMENTS

Identical reference numbers used in different figures designate identical, corresponding or functionally similar elements.

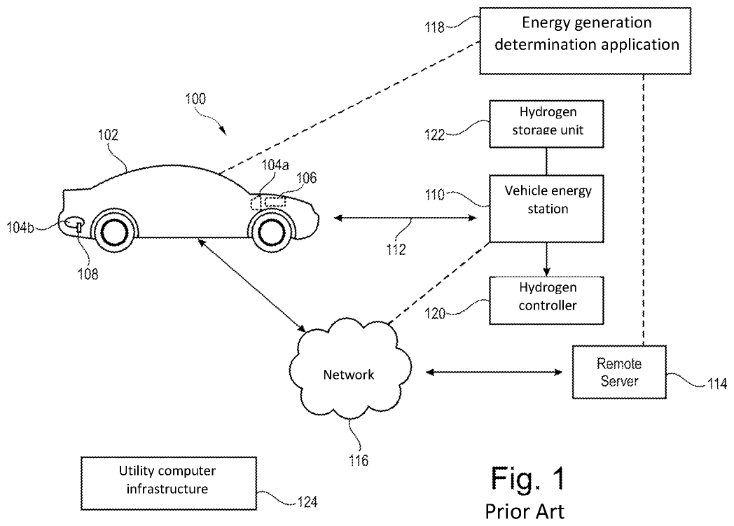

FIG. 1 schematically shows the structure of a system 100 for data exchange between a vehicle 102, in particular a hydrogen fuel cell vehicle, and a refueling station, wherein the vehicle 102 is powered by an electric motor 106 and an electric storage mechanism, e.g. a battery 104a. The electrical energy can be provided by a fuel cell (not shown), which is supplied with hydrogen by a hydrogen storage tank 104b. The hydrogen storage tank 104b may have a hydrogen storage sensor 108 for detecting the hydrogen level.

The illustrated system further comprises a vehicle energy station 110, such as a hydrogen refueling station, which can fill or refuel the vehicle with fresh hydrogen (fuel) via a hydrogen supply line 112. Here, the vehicle energy station 110 is controlled by a hydrogen controller in such a way that it produces hydrogen on site if necessary. The hydrogen controller 120 also includes a communication device (not shown) that allows the controller 120 to communicate with one or more components such as the vehicle 102 via a wireless communication network 116. For example, the hydrogen control device can be configured to receive messages from the remote server (cloud-based server) or the vehicle 102 that are used for the production of hydrogen. The production of hydrogen can be controlled in such a way that hydrogen is stored in hydrogen storage units 122.

The system shown further comprises an energy generation determination application 118 that determines and accordingly generates the amount of hydrogen to be provided based on an arrival of vehicles 102 at the refueling station 110. Furthermore, the system has a utility computer infrastructure 124, which may comprise one or more computer devices (not shown), and by means of which the vehicle energy station (refueling station) can communicate with electricity suppliers and, based on the determined hydrogen requirement, requests and orders the necessary energy requirement (electricity requirement) from different electricity suppliers.

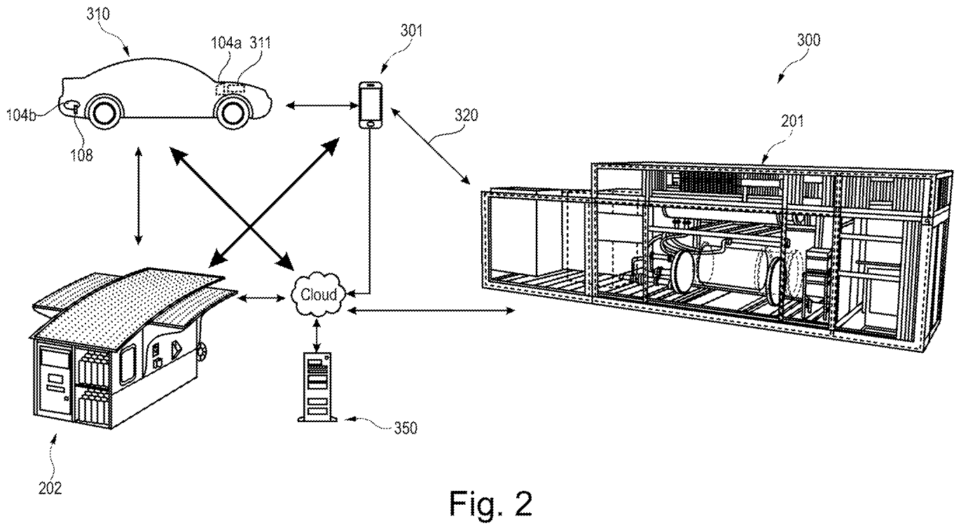

FIG. 2 schematically shows the structure of a system 300 for data exchange between a plurality of clients 301, 310 and refueling stations 201, 202 according to an embodiment of the present invention.

The illustrated system 300 or management system has a stationary refueling station 201, a mobile refueling station 202, a first client 301 in the form of a smartphone and a second client 310 in the form of a vehicle. Furthermore, the illustrated system 300 comprises a remote server 350 or cloud-based server which is used to exchange data between the two hydrogen refueling stations 201, 202 and the two clients 301, 310, in particular via wireless data transmission in the form of digital mobile communications, Bluetooth or WLAN. Furthermore, the remote server 350, the two refueling stations 201, 202 and/or the two clients 301, 310 have means, in particular computer programs (which can be implemented as apps in the case of mobile terminal devices such as smartphones) and databases, which are configured to carry out the steps of the afore-described computer-implemented method for data exchange between at least one refueling station and at least one client.

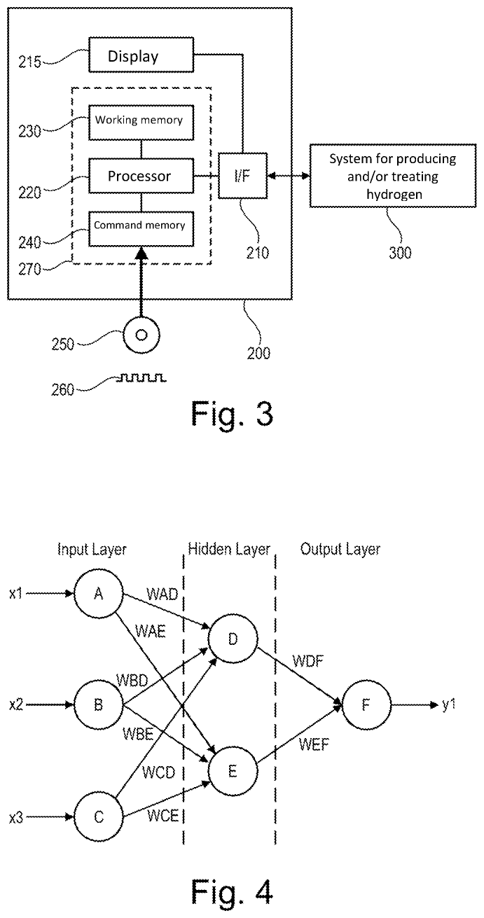

FIG. 3 shows a block diagram illustrating a signal processing hardware of the system 300 shown in FIG. 2 according to an embodiment of the present invention, which can be configured to function as a controller of one of the two refueling stations 201, 202 shown in FIG. 2 or as a controller or application software of one of the clients shown in FIG. 2.

The programmable signal processing hardware 200 comprises a communication interface (I/F) 210 for receiving the refueling requests or refueling proposals described above, the states or operating parameters, for generating the instructions for the system 300 to exchange data between a plurality of clients 301, 310 and a plurality of refueling stations 201, 202, to perform control of the at least one refueling station 201, 202, in particular to perform control of the production and/or treatment of hydrogen, and the like. The signal processing device 200 further comprises a processor, control unit (e.g. a central unit, CPU, or a graphics processing unit, GPU) 220, a working memory 230 (e.g. a random access memory), and a command memory 240 storing a computer program comprising the computer-readable instructions/commands which, when executed by the processor 220, cause the processor 220 to perform or control various functions, including those of the system 300 for producing and/or treating hydrogen for refueling at least one vehicle, and optionally of a display control signal generator. The command memory 240 may comprise a ROM (e.g. in the form of an electrically erasable programmable read-only memory (EEPROM) or a flash memory) that is preloaded with the computer-readable commands. Alternatively, the command memory 240 may comprise a RAM or similar type of memory, and the computer-readable commands of the computer program may be input thereto from a computer program product such as a non-transitory computer-readable storage medium 250 in the form of a CD-ROM, DVD-ROM, etc., or a computer-readable signal 260 containing the computer-readable commands. In each case, the computer program, when executed by the processor, causes the processor to execute at least one of the computer-implemented methods described herein. However, it should be noted that the controller according to the invention can alternatively be implemented in non-programmable hardware such as an application-specific integrated circuit (ASIC).

In the present embodiment of the present invention, a combination 270 of the hardware components shown in FIG. 3, comprising the processor 220, the working memory 230, and the command memory 240, is configured to perform functions of the system 300 for producing and/or treating hydrogen for refueling at least one vehicle, these functions being described in detail below. In embodiments such as the present embodiment of the present invention, in which the system 300 comprises a display control signal generator, the functionality of this optional component may also be provided by the combination 270 of the hardware components together with the communication interface 210.

As can be seen from the following description of the processes performed by the controller according to the invention and/or the system 300 of the present embodiment, the controller and/or the system 300 automatically processes refueling requests, refueling proposals, states and operating parameters of the refueling stations, desired refueling parameters, refueling forecasts, environmental influences such as weather conditions, outside temperature, day of the week, vacation or travel time, energy prices, availability of green energy, number of scheduled refueling processes detected by corresponding sensors or transmitted by the clients to determine a very accurate refueling schedule forecast and in association therewith a hydrogen and/or energy requirement forecast.

FIG. 4 schematically shows a neural network with artificial neurons with an input layer, a hidden layer and an output layer.

The time-series-forecast algorithm described above may be a neural network, as in the present embodiment. Neural networks automatically generate identifying features by processing the input data such as the states (status data) and/or operating parameters detected by the at least one refueling station, the refueling requests transmitted by the clients without any prior knowledge.

As shown in FIG. 4, a neural network generally consists of an input layer and an output layer as well as several hidden layer(s). Each of these layers consists of a plurality of artificial neurons (designated A through F in FIG. 4), and each layer can perform different types of transformations on its inputs. Each artificial neuron can be connected to several artificial neurons in neighboring layers. The output of each artificial neuron is calculated by a non-linear function of the sum of its inputs. Artificial neurons and the connections between them usually have corresponding weightings (WAD, WAE, etc. in FIG. 4), which determine the strength of the signal at a particular connection. These weightings are adjusted during the learning process, as a result of which the output of the neural network changes. The signals travel from the first layer (the input layer) to the last layer (the output layer) and can pass through the layers several times.

### LIST OF REFERENCE NUMBERS

200 Signal processing device
201 Hydrogen refueling station
202 Mobile hydrogen refueling station
210 I/F interface
215 Display
220 Processor
230 Working memory
240 Command memory
250 Computer-readable storage medium
260 Computer-readable signal (program)
270 Combination
300 System
301 Smartphone (client I)
310 Vehicle (client II)
311 Electronic communication device
320 Wireless data transmission
350 Remote server (cloud-based server)

1. A computer-implemented method for data exchange between at least one refueling station, in particular hydrogen refueling station, and a client, the method comprising:
transmitting a refueling request from the client to the at least one refueling station via wireless data transmission,
receiving at least two refueling proposals from the at least one refueling station for the client's refueling request via the wireless data transmission,
wherein the at least two transmitted refueling proposals differ from one another in at least one proposed refueling parameter, selected from the group of: refueling time, refueling duration, maximum filling amount, maximum filling speed (l/s), energy required for refueling on the part of the refueling station, price of hydrogen, waiting time before refueling, type of energy used to produce the hydrogen to be refueled, CO2 certificate and environmental certificate.

2. The computer-implemented method according to claim 1, further comprising:
preselecting at least one desired refueling parameter selected from the group of: refueling time, refueling duration, maximum filling amount, maximum filling speed, maximum energy required for refueling, price of hydrogen, waiting time before refueling, type of energy used to produce the hydrogen to be refueled, CO2 certificate and environmental certificate by the client, in particular by a user of the client, prior to the transmission of the refueling request from the client to the at least one refueling station, wherein the refueling request comprises the at least one desired refueling parameter.

3. The computer-implemented method according to claim 2, wherein the at least two transmitted refueling proposals have the at least one desired refueling parameter in common and differ from each other in at least one of the remaining proposed refueling parameters, wherein the proposed refueling parameters are determined taking into account the desired refueling parameters.

4. The computer-implemented method according to claim 2, further comprising:
selection of one of the at least two transmitted refueling proposals by the client, in particular by a user of the client, and
transmission of a confirmation of the selected refueling proposal from the client to the at least one refueling station,
wherein the at least one refueling station reserves a corresponding refueling process based on the received confirmation and confirms the reservation to the client.

5. The computer-implemented method according to claim 2, comprising:
detecting a state or operating parameter of the at least one refueling station, comprising at least one parameter selected from the group of: amount of stored hydrogen, temperature of stored hydrogen, pressure of stored hydrogen, number of free fuel pumps, number of refueling processes in progress, utilization of the refueling station, energy price, availability of green energy, number of scheduled refueling processes, costs of the reserved refueling processes depending on the time and amount of hydrogen that can be provided by means of logistics,
consideration of the desired refueling parameters transmitted by the client or of the detected state or operating parameter of the at least one refueling station in the determination of the at least two refueling proposals, in particular by the at least one refueling station.

6. The computer-implemented method according to claim 1, further comprising:
acquiring data representing at least one scheduled or reserved refueling process, comprising data selected from the group of: refueling time, calculated refueling duration, maximum filling amount, maximum filling speed, maximum energy required for refueling, calculated price of hydrogen, type of energy used to produce the hydrogen to be refueled,
generating a refueling forecast, in particular forecast refueling schedule, over a predetermined first time period, by applying a refueling schedule forecast algorithm to the acquired data.

7. The computer-implemented method according to claim 6, wherein the refueling schedule forecast algorithm has been trained on:
history data or data collection(s) representing an accumulation of individual refueling processes over a second predetermined time period, and
refueling time or time of day of the respective refueling process within the second predetermined time period.

8. (canceled)

9. (canceled)

10. The computer-implemented method according to claim 6, wherein the refueling schedule forecast algorithm also takes into account metadata when generating or determining the refueling forecast, the metadata being selected from the group comprising: number of fuel pumps, average dispensing capacity per fuel pump, geographic location, particularly metropolitan area, rural location, proximity to a transport hub, proximity to an industrial area, and average annual dispensing capacity.

11. (canceled)

12. (canceled)

13. The computer-implemented method according to claim 1, further comprising:
acquiring data representing at least one refueling process performed by the client, comprising data selected from the group of: refueling time, refueling duration, filling amount, maximum filling speed, energy required for refueling, price of hydrogen, type of energy used to produce the refueled hydrogen, within a fourth time period,
generating a history or data collection of the acquired data over the fourth time period,
generating a client refueling pattern of hydrogen by applying a client refueling pattern determination algorithm to the generated history or data collection of the acquired data,
wherein the client refueling pattern determination algorithm is an algorithm, in particular a time-series-forecast algorithm, trained on a history/histories or data collection(s) representing an accumulation of individual refueling processes over a fifth predetermined time period, and determines or defines client refueling patterns using one or more machine-learning algorithms.

14. The computer-implemented method according to claim 13, wherein the fourth time period extends over one year, 6 months, 3 months, 1 month, two weeks or 1 week, or the fifth time period extends over 30 days, 60 days, 90 days, 180 days, one year or two years.

15-20. (canceled)

21. The computer-implemented method according to claim 13, further comprising:
creating a default desired refueling profile by the client, in particular an operator of the client, comprising at least one desired refueling parameter selected from the group of: refueling time, refueling duration, maximum filling amount, maximum filling speed, maximum energy required for refueling, price of hydrogen, waiting time before refueling, type of energy used to produce the hydrogen to be refueled.

22. (canceled)

23. The computer-implemented method according to claim 1, wherein if the at least one transmitted desired refueling parameter of the client is refueling with green hydrogen, the at least one refueling station ensures that the hydrogen to be refueled was produced using only renewable energies such as solar energy, wind energy, biomass, hydropower or geothermal energy, and this is logged to the client after the refueling has been performed, in particular certified by means of an environmental certificate.

24. The computer-implemented method according to claim 1, further comprising:
collecting refueling requests transmitted by a plurality of clients in a database of a cloud-based server,
collecting states or operating parameters or refueling forecasts of a plurality of refueling stations in the database,
transmitting at least two refueling proposals from the database to at least one of the clients, wherein the collected states or operating parameters or refueling forecasts of the individual refueling stations or the transmitted refueling requests of the plurality of clients are taken into account when preparing the refueling proposals.

25. The computer-implemented method according to claim 24, wherein based on the collected states or operating parameters or refueling forecasts of the individual refueling stations or the transmitted refueling requests of the plurality of clients or client-related parameters selected from the group of: distance to the respective refueling stations, hydrogen amount remaining in the vehicle, scheduled travel route of the respective client, optimized refueling proposals are determined, wherein the refueling proposals are optimized with regard to the distance to the selected refueling station, filling speed, waiting time, price of hydrogen, and utilization of the refueling station.

26. The computer-implemented method according to claim 1, wherein a filling process or a correspondingly suitably located refueling station is proposed to the client depending on the filling level in the high-pressure storage tank of the vehicle or a predetermined driving distance.

27. The computer-implemented method according to claim 1, wherein the wireless data transmission is digital mobile communications, Bluetooth or WLAN (Wireless Local Area Network).

28. A computer-implemented method for controlling, with or without feedback, a refueling process of a vehicle or client, the method comprising:
checking whether at least one refueling parameter about at least one refueling process already performed on the vehicle or client or a client type is available, selected from the group of: refueling duration, filling amount, maximum filling speed, temperature curve of the filled hydrogen, temperature curve of the hydrogen filled into the vehicle-side high-pressure storage tank(s), refueling curves (delta-P temperature curve),
if at least one refueling process parameter is available for the vehicle to be refueled or client or client type, this will be taken into account or optimized during the refueling or the filling process.

29. The computer-implemented method according to claim 28, wherein the vehicle type, in particular the type of the installed hydrogen system, of the vehicle or client or client type, is queried before the refueling process of the vehicle or client is performed, which is done via a code, in particular a QR code, attached to the vehicle or the client or via data exchange by means of wireless data transmission.

30. The computer-implemented method according to claim 28, wherein the method further comprises:
creating a refueling curve, in particular delta-P temperature curve, based on refueling parameters of the at least one refueling process already performed on the vehicle or client or a client type,
wherein the refueling curve is created or optimized based on the available refueling parameters selected from the group of: refueling duration, filling amount, temperature curve of the filled hydrogen, temperature curve of the hydrogen filled into the vehicle-side high-pressure storage tank(s), pressure increase in the vehicle-side high-pressure storage tank(s) and degree of filling achieved, or
state or operating parameters of a filling device, in particular hydrogen refueling station, selected from the group of: temperature of stored available hydrogen, pressure of stored hydrogen, number of refueling processes in progress, utilization of the refueling station, energy price, availability of renewable or green energy, and number of scheduled, pending or confirmed, refueling processes within a certain time period.

31. The computer-implemented method according to claim 30, wherein the refueling duration of a scheduled refueling process of a vehicle or client is reduced by a predetermined or determined value if, when checking the refueling parameters of refueling processes already carried out on the same vehicle, client or client type, it is determined that a maximum permissible high-pressure storage tank temperature was not reached at the end of the refueling processes performed.

32. A computer-implemented method for detecting a user consumption pattern or user refueling pattern, in particular of a driver of a vehicle powered by hydrogen, the method comprising:
acquiring data representing at least one refueling process performed by a client, comprising data selected from the group of: refueling time, refueling duration, filling amount (refueled amount of hydrogen), maximum filling speed, energy required for refueling, price of hydrogen, type of energy used to produce the refueled hydrogen, within a fourth time period,
generating a history or data collection of the acquired data over the fourth time period,
generating a client refueling pattern of hydrogen by applying a client refueling pattern determination algorithm to the generated history or data collection of the acquired data,
wherein the client refueling pattern determination algorithm is an algorithm, in particular a time-series-forecast algorithm, trained on a history/histories or data collection(s) representing an accumulation of individual refueling processes over a fifth time period, and determines or defines client refueling patterns using one or more machine-learning algorithms.

33. The computer-implemented method according to claim 32, wherein the fourth time period extends over one year, 6 months, 3 months, 1 month, two weeks or 1 week, or the fifth time period extends over 30 days, 60 days, 90 days, 180 days, one year or two years.

34. The computer-implemented method according to claim 32, wherein the client refueling pattern determination algorithm has been trained on:
history data or data collection(s) representing an accumulation of individual refueling processes over the fifth time period, and
refueling time or time of day of the respective refueling process within the fifth time period.

35. The computer-implemented method according to claim 21, the method further comprising:
detecting a state or operating parameter of the hydrogen refueling station, comprising at least one parameter selected from the group of: amount of stored hydrogen, temperature of stored hydrogen, pressure of stored hydrogen, number of free fuel pumps, number of refueling processes in progress, utilization of the refueling station, energy price, availability of renewable or green energy, number of scheduled, pending or confirmed, refueling processes within a certain time period, costs of the reserved refueling processes depending on the refueling duration and logistics for hydrogen,
controlling, with or without feedback, hydrogen production or hydrogen treatment, taking into account the created refueling station refueling pattern and the detected state or operating parameter of the hydrogen refueling station.

36. The computer-implemented method according to claim 35, further comprising:
determining a necessary hydrogen storage amount based on the created refueling station refueling pattern, wherein the amount of stored hydrogen, the cooling temperature of the stored hydrogen, and the pressure of the stored hydrogen are determined based on the created refueling station refueling pattern, in particular the respective refueling profiles of the scheduled refueling processes, wherein the hydrogen storage amount, the cooling temperature of the stored hydrogen, and the pressure of the stored hydrogen are kept as low as possible, approximately in a range of 10% to 20% more than a requirement determined based on the refueling station refueling pattern.

37-42. (canceled)
